(19) United States
(12) Patent Application Publication
(10) Pub. No.: US 2024/0138425 A1
(43) Pub. Date: May 2, 2024

(54) SYSTEM TO CUT BLOCKS OF MEAT

(71) Applicant: MP EQUIPMENT, LLC, Gainesville, GA (US)

(72) Inventors: Edwin E. KING, Gainesville, GA (US); Ernest MERRILL, Gainesville, GA (US)

(21) Appl. No.: 18/374,345

(22) Filed: Sep. 28, 2023

Related U.S. Application Data
(60) Provisional application No. 63/419,975, filed on Oct. 27, 2022.
(60) Provisional application No. 63/424,672, filed on Nov. 11, 2022.

(51) Int. Cl. A22C 17/00

(52) U.S. Cl. CPC A22C 17/0086; A22C 17/0033

(57) ABSTRACT

A method to identify a desired portion of a food block to be pressed is provided. The method includes preparing an image of a food block, the food block provided within a system that is adapted to cut the food block into a size that is desired for sale, and in some embodiments for cutting into multiple smaller salable pieces. A rectangle is identified for cutting a block of meat within a projection of the food block within the image, wherein the rectangle includes a possible front end cut, a possible right side cut, a possible left side cut, and a possible rear side cut. Various adjustments to the positioning and the size of the rectangle are considered based upon one or more identifiable aspects of the food block from the image, and establishing a final cutting geometry with a final front end cut, final right side cut, final left side cut, and final rear side cut.

### CROSS-REFERENCE TO RELATED APPLICATIONS

This application claims priority from United States Provisional Application Nos. 63/419,975, filed on Oct. 27, 2022, and 63/424,672, filed on Nov. 11, 2022, the entirety of which are each hereby incorporated by reference herein.

### TECHNICAL FIELD

The disclosure relates to a system to cut a block of food, such as meat (such as a pork belly) into a size and shape that is suitable to be pressed by a pressing apparatus. The pressed cut block of food is pressed to a size and shape that is suitable for cutting into individual salable pieces of food, or used in a further food processing step.

### BRIEF DESCRIPTION OF THE DRAWINGS

FIG. 1 is image of a food block with an initial cutting plan.

FIG. 1A is a schematic drawing showing a scan of a specific portion of the food block.

FIG. 1B is a view depicting the height of the food block along the width of the food block based upon the image taken in FIG. 1A.

FIG. 1C is a combined image of all of the scanned information of the food block in accordance with FIGS. 1A and 1B, with all of the successive scanned information or images being aligned together to depict an image of the entire food block.

FIG. 2 is the image of the food block of FIG. 1 with an adjusted cutting plan.

FIG. 3 is the image of the food block with geometric footprint provided as well as comparison between the initial cutting plan and the geometric footprint.

FIG. 4 is an image of a food block that is positioned within a scanning machine in a position that is angularly offset from a position generally parallel to the Y axis of the scanning machine.

FIG. 5 is an image of a food block where an adjusted cutting plan is identified to avoid or minimizes inclusion of voids and areas of high concentration of fat.

FIG. 5A is an image of the food block with a grayscale image of a food item (upper image) and a grayscale height map image (lower image) of the same food item, wherein in the grayscale height map image darker shades represent relatively thin portions of the food block and lighter shades represent relatively thick portions of the food block, both images within the figure include the same cutting block and lines depicting modifications to the cutting block resulting from the methods disclosed herein.

FIG. 5B is a schematic image of a food block where different symbols are provided with represent different thickness, with sections that include a “+” symbol identifying thick sections, areas with an “@” symbol identifying sections that are thinner than the “+” sections, and areas with a “#” symbol identifying sections that are thinner than the “@” sections, with an area to be cut positioned to avoid the majority of the relatively thin portions of the food.

FIG. 5C is a simplified block diagram of a method of adjusting the cutting plan based upon an identified thickness of the food block.

FIG. 5D is a simplified block diagram of a method of adjusting the cutting plan based upon a comparison of the volume of the food block with a volume of the pressing die.

FIG. 5E is a simplified block diagram of a method of adjusting the cutting plan when a percent die fill is specified.

FIG. 6 simplified block diagram of at least one embodiment of a processing system for cutting food blocks.

FIG. 7 is a simplified block diagram of at least one embodiment of various environments of the processing system of FIG. 6.

FIG. 8 is a simplified flow diagram of at least one embodiment of a method for cutting food blocks.

### DETAILED DESCRIPTION OF THE DRAWINGS

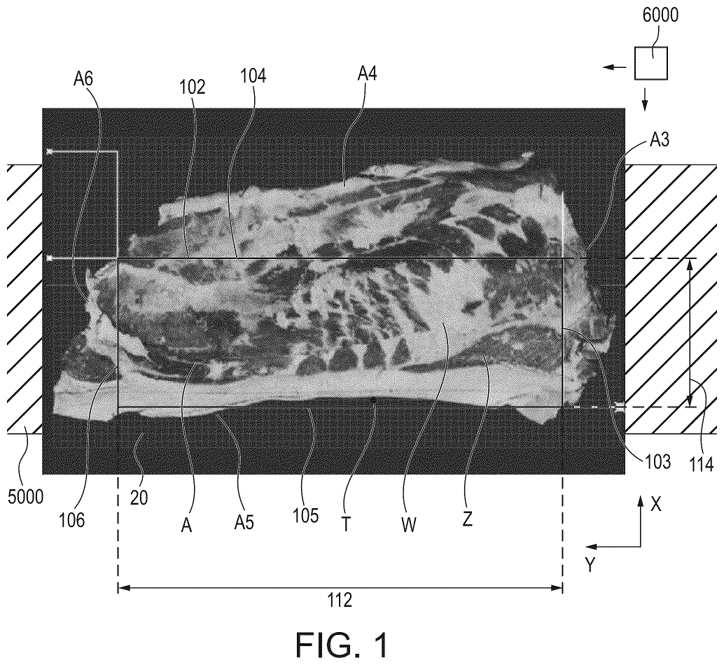

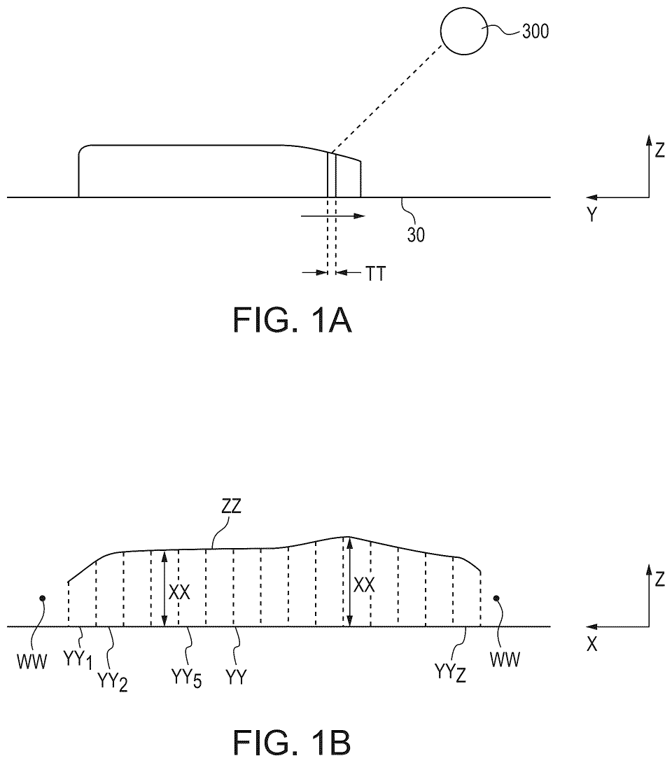

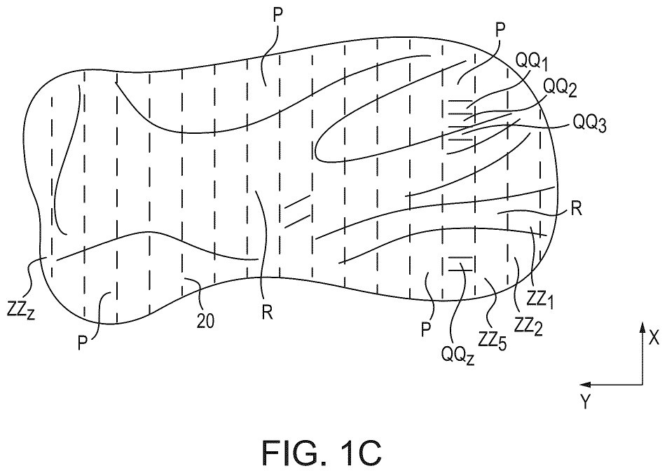

Turning now to FIGS. 1-8 the subject disclosure relates to a process for identifying the material within a large food item to be cut, which leads to optimization of the cut item into one or more salable items. The subject disclosure is drafted specifically for use with a system to process and cut meat blocks, such as pork bellies, but can readily be adapted for other naturally occurring items (either animal or plant based) that are intended to be sold, such as for human or animal consumption. Other animal based food items could be chicken, beef, fish, and the like.

The disclosure relates to a processing system where bulk foods are received with the system identifying the geometry and quality of the bulk food item, identifying based upon the identified geometry and quality how the bulk food item is aligned for travel through the system, such as via a conveyor belt, based upon the identified geometry, quality, and alignment identify a strategy for cutting the food item into a size that is capable of being further processed (such as pressed), and based upon the strategy cutting the food item, preferably as the food item moves through the system. The step of identifying a strategy for cutting the food item may also include a step of identifying a strategy for further cutting the food item into a plurality of smaller pieces that are of a saleable size, or of a smaller size that is desired for further processing. The processing system may include the step of pressing the cut food item to form the cut food item into a size and geometry that is desired for cutting to the plurality of smaller pieces that are of saleable size or of a smaller size that is desired for further processing.

The disclosure relates to a processing system that receives a food item A upon a moving mechanism, such as a conveyor, a track or the like (schematically 5000), or the food item may be moved individually through the processing system via other means.

The disclosure relates to a processing system where the steps of identifying the geometry and quality of the bulk food item, identifying based upon the identified geometry and quality how the bulk food item A should be cut into a size capable of being further processed, and cutting the food item based upon the strategy all occur when the food item is continuously or discontinuously moving until cut food item is to be pressed. In some embodiments, the cut bulk food item may be pressed in one or more directions as the bulk food item continues to move at the same or a modified speed, while in other embodiments, the cut bulk food item may be pressed when the cut bulk food item is not moving (with a conveyor or other movement system). The pressing may be in one or more directions, such as in a direction along the length of the bulk food item, along the width of the bulk food item, and along the height of the bulk food item A. The pressing operation may be controlled by a controller that receives information regarding the strategy for cutting the food item into a cut bulk food item, such that the pressing of the bulk food item results in a bulk food item that is compressed into a geometry and size that is configured to be cut into the plurality of smaller pieces that are of saleable size or of a smaller size that is desired for further processing.

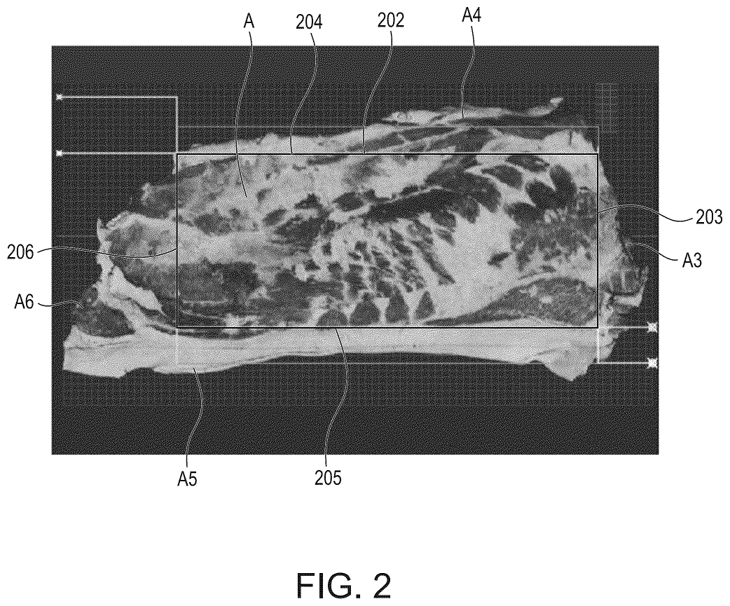

FIGS. 1 and 2 represent schematic possible optical characterizations of a food block A to be cut, initially into a usable bulk size for further processing (such as pressing and cutting into individual pieces for sale or further use). In the images a pork belly is presented, with the system using an image 20 (such as a photograph, an x-ray image, a greyscale image, an image from wavelengths that are not visible to the human eye, an ultrasound image, or the like) to identify the geometry and quality of the food block A presented.

The image 20 may be a photographic image, or it may be an image that is prepared by other than a photograph of the surface of the food block. For example, with reference to FIGS. 1A-1C, the image 20 may be prepared by moving the food block past an image scanner 300 along a conveyor 30. The image scanner 300 is configured to scan a specific portion of the food block along the width of the food (X direction) for a specific length of the food block (TT, direction Y—such as 1 mm of length of the food block). The scanner 300 may identify the height (direction Z, perpendicular to directions X and Y) of the portion of the food block that is aligned with the sensor, specifically the height profile along the width of the specific width being scanned. FIG. 1B depicts the data obtained by the scanner, which relates to the height profile ZZ of the food block along the specific width (e.g. TT) that is being scanned—with the height corresponding to the distance XX between the scanned line ZZ (representing the top surface of the food block) and a datum line YY that represents the surface that the food block rests upon. The areas (WW) outboard of the XX are areas where no food was scanned—and these combined areas serve, when the overall image is prepared as discussed below, to identify the edges of the food block. The scanner 300 may also scan the color of the food block along each width scan, with the color representing the type of localized portion of the food block—i.e. a light color representing fat (P), a darker color representing muscle (R). Alternatively or additionally, the scanned line ZZ may vary based upon its intensity along the length of the scanned line, with areas that are more intense (i.e. brighter or more uniform) are calibrated to a type of localized portion of the food block. Still alternatively, or additionally, the scanned line may have a vary spread along its length, i.e. in some positions along the line may be relatively thin (e.g. one two two pixels tall along the image) and other positions may be relatively wide (e.g. 3, 4, or 5 pixels tall along the line). The amount of spread may be calibrated to a type of localized portion of the food block, e.g. the thin portions are known to be positions of lean food (e.g. muscle) and the thick portions are known to be positions of high fat concentration. The spread may also be understood in combination with intensity, i.e. if there is a high spread but the intensity is highest at the center of the line and intensity decreases away from the center of the line it might be calibrated to a certain type of localized portion (e.g. fatty) while if the intensity is constant or nearly constant along the spread it might be a different type of localized portion. One of ordinary skill in the art with a thorough knowledge and understanding of this disclosure as well as the output of the scanned line ZZ based upon the type of scanning system 300 that is being used, would be able to calibrate the system to take knowledge about the localized portion of the food block and use that data within the methods discussed herein. For the sake of brevity—each of these possibilities are collectively referred to as image quality. IN other words, image quality can include one or more of image color, image spread, image intensity as discussed herein (as well as possible combinations of two or more of these—i.e. a combination of image color and image spread, or a combination of image spread and image intensity—, with the system being programmed to determine the characteristic of that localized portion based upon the image quality at specific portions along line ZZ. The system saves the data representative of the height at a specific position (e.g. in 1 mm sections along the width, e.g. YY₁, YY₂, YY₃ . . . YY_{Z}) along the width as well as the identified color at a specific position along the width and saves all of the height values and image qualities for each position along each width, and saves each different width. As a result, the system has data for height and image quality along every individual area (e.g. FIG. 1C, QQ₁, QQ₂, QQ₃ . . . QQ_{z}) of the surface of the food block (such as every square mm per the example herein) of the food block once all of the width sections are scanned to form the entire length of the food block. In some embodiments, the width “slices” (TT) that are scanned may have a dimension in the length direction of 1 mm, 0.5 mm, 1.5 mm, 2 mm or the like—based upon the accuracy needed as well as based upon the processing power of the system. Similarly, each width slice may be separated into 1 mm segments (or 0.5 mm. 1.5 mm, 2.0 mm, or the like) such that each scanned unit (QQ) is, for example 1.0 mm squared of surface of the food block.

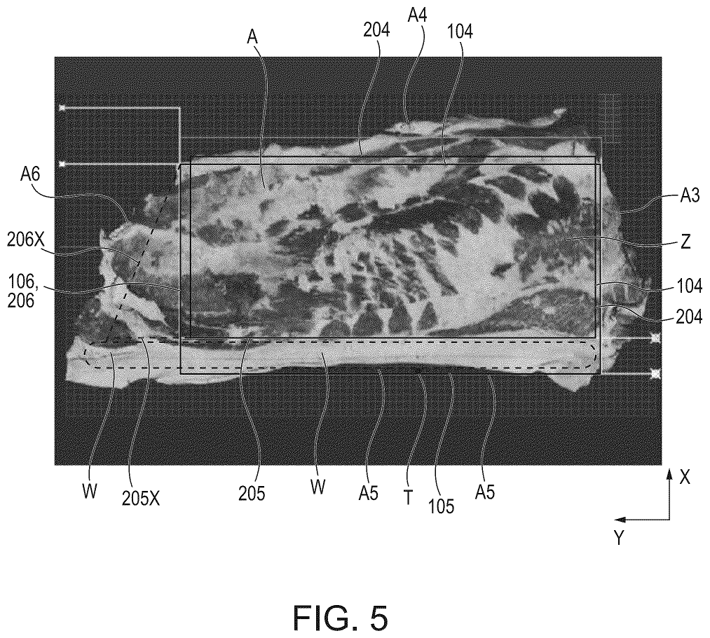

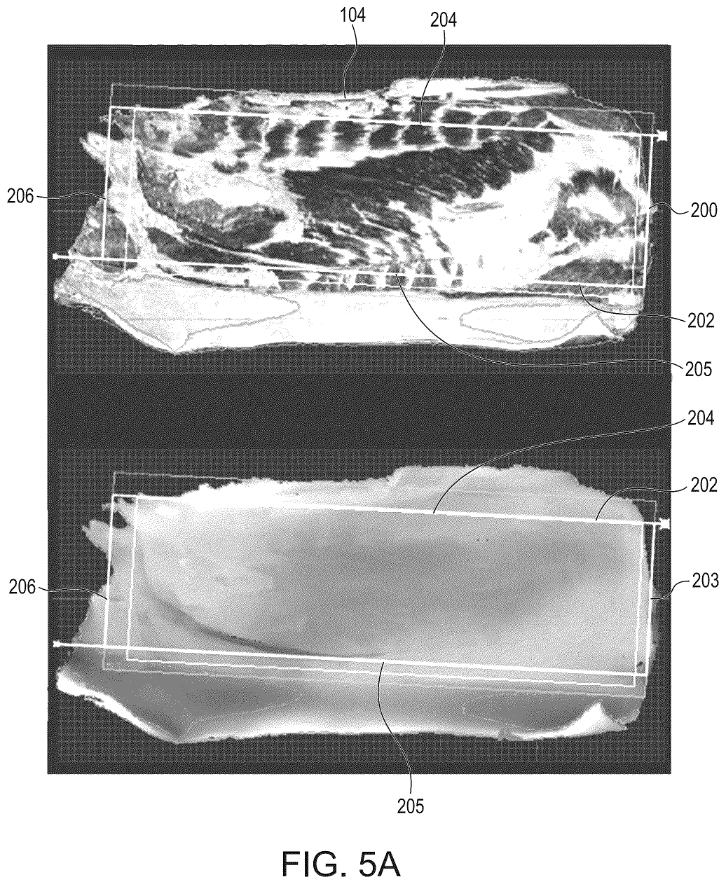

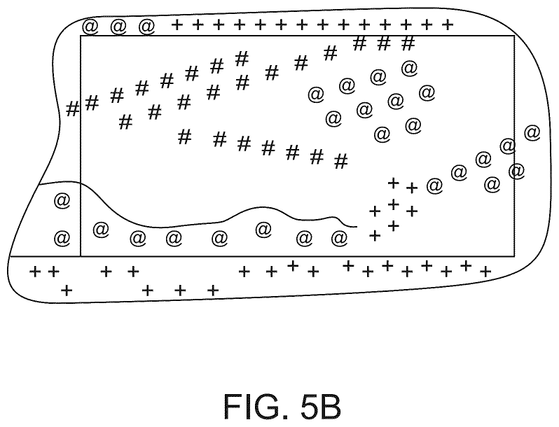

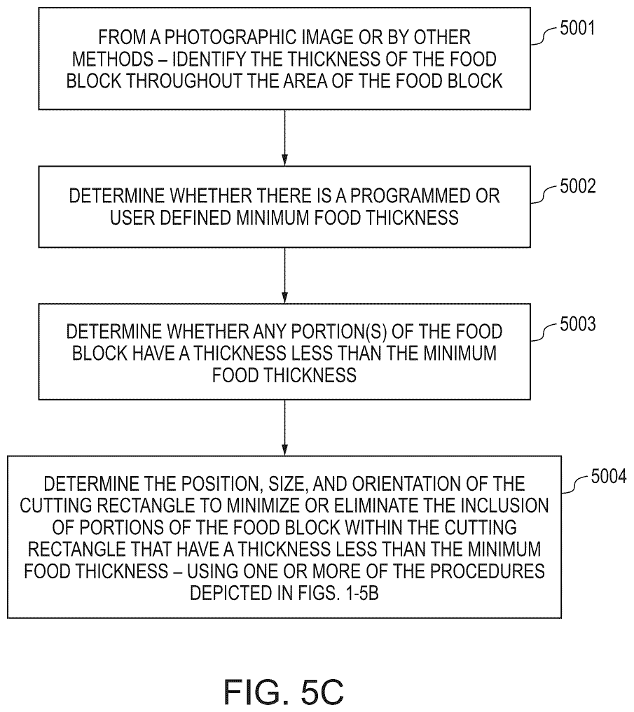

This scanning provides for the height of each scanned unit (QQ) to be stored numerically within the storage of the system, along with information representative of the scanned image quality of each scanned unit. As depicted schematically in FIG. 1C, the system may prepare an image of the food block by applying each scanned width data upon an image with the adjacent width scans being positioned next to each other ZZ₁, ZZ₂, ZZ₃ . . . ZZ_{z}. The image includes the measured image qualities for each section of each width—and therefore provides an image that is representative of the appearance of the top surface of the food block, and the combined scanned image quality (in embodiments where image color is directly scanned—or color being imputed into the image where color is indirectly scanned as a function of other types of image quality that are predictive of color) placed next to each other represent the areas of the food block that have a high concentration of fat (P) and other areas that have high concentration of muscle (R). The system also can prepare an image that is color coded or in grayscale where different colors represent different heights of the food block (, or different shades of grayscale in a grayscale image represents different heights of the food block, as discussed elsewhere herein and depicted in FIG. 5A (lower image). The images that are prepared under this example method are used to optimize the cutting strategy of the food block as discussed herein.

By geometry, the system identifies the width (along the X direction) and the length (along the Y direction) of the food block A that is being monitored, and specifically identifies the geometric position of the outer edges A3, A4, A5, A6 of the food product upon a coordinate system, from the perspective of that the image is prepared. In preferred embodiments, the image is representative of the top surface of the food product as it rests upon the moving apparatus (e.g. the surface of the conveyor) and therefore the geometry that is identified is the projection of the length (front to back—along the direction that the food item moves along the conveyor) and the width (left to right, perpendicular to the front to back, with the width directions generally parallel to the direction of movement of the food product along the conveyor. Preferably the image prepared with the food item resting upon (or in the same image as) a reference grid of a known size, so that the various dimensions of the food item can be calculated with reference to the known dimensions of the reference grid. Additionally, as discussed below, the system can identify the position of certain identifiable anatomic landmarks within the food item, as well as the size of the anatomic landmarks within the food item. Further, the image may be consulted to identify the locations (and the concentration) of portions that are determined to be primarily muscle (e.g. typically the darker portions on a greyscale image) and primarily fat (e.g. typically the lighter portions on a greyscale image). With reference to FIG. 1, darker portions are identified as Z and lighter portions are identified as W.

From the identified geometry, a nominal size and position of a cutting strategy (cutting rectangle) 102 is established, which includes proposed front cut 103, left side cut 104, right side cut 105, and rear cut 106 that are to be made to trim the food item to the desired bulk food item—which will, in some embodiments, be pressed into a final size and geometry (final cutting strategy 202). The nominal cutting strategy 102 is typically the largest rectangle that can fit within the geometry of the bulk food item. In some embodiments, the nominal cutting strategy may be a rectangle that fits entirely within the bulk food item. In other embodiments, the nominal cutting strategy may be the largest rectangle that fits almost completely within the bulk food item, although a very small portion may rest outside of the rectangle, such as space T identified in FIG. 1. In some embodiments, the nominal cutting strategy 102 may be identified as the largest rectangle where all four corners fall within the bulk food item, but a portion of one or more of the lines forming the rectangle may extend outside of the bulk food item (space T). In some embodiments, the nominal cutting strategy 102 may be the largest rectangle that is formed where a certain percentage of the area of the rectangle encloses bulk food item, such as 95% of the area of the food is enclosed (e.g. the “very small portion” in this example is 5%), 98% of the area is enclosed (the very small portion in this example is 2%), or other significant percentages of the area is enclosed—with, for example, the very small portion being 10% or lower, including all percentages less than 10%.

In some embodiments, the various cuts may be made in sequence as the food block is moved with respect to the cutting station. For example, a cutting device (6000, schematic) (which may be a knife, a cutting blade, a water jet cutting system, a laser cutter, a heated wire, or the like) may be movable along an X-Y plane to allow the same cutter to sequentially perform each of the cuts as the food block moves through the cutting station. By way of example, in an embodiment with a single cutter is used to cut the food block, the cutter first makes the front cut, then the left cut, then the rear cut, then the right cut. In embodiments where the food block is cut while moving through the cutting station, the controller controls the movement of the cutter such that it necessarily moves in directions that are not always purely in only the X direction or purely in only the Y direction, but instead in order to make the cuts the cutter moves in one or more directions that has both X and Y components.

In other embodiments two cutters are provided, such as a first cutter that is configured to make the front cut and then the left cut, and a second cutter that is configured to make the rear cut and then the right cut. The two cutters may operate simultaneously, or sequentially. As with the single cutter, the two cutters may move in directions that have X and Y components to make the necessary cuts.

In some embodiments, the cutting strategy 102 is a rectangle with a length 112 (along the movement direction 1002) and a width 114 (perpendicular to the movement direction 1002 and parallel to the conveyor (or other structure) that the food item rests upon or is supported by).

In some embodiments, the cutting strategy 102 results in a cut geometry (typically a rectangle) that that will fit within a downstream pressing machine, which is typically rectangular. The pressing machine accepts a food item that is a certain width (dimension in the direction Y) and a certain length (dimension in the direction X). The pressing machine may initially press the food item in the width direction, which tends to increase the thickness of the food item (thickness is the height of the food item above the surface that the food item rests upon) and may increase the length of the food item if not pressed or constrained in the length direction. The strategy of identifying the final cutting geometry may involve establishing a final cutting geometry that is equal or only slightly smaller than the maximum width that can be accepted within the pressing machine—subject to one or more strategies discussed herein and depicted in FIGS. 2-5B involved with establishing the final cutting geometry—such that a food item with a maximum width is received and then pressed in the width direction to increase the thickness of the pressed food item. The food item can be cut to a width such that as the food item is pressed, it achieves the maximum thickness allowed by the pressing machine while being pressed to a desired width. This embodiment may be specifically combined with the embodiment of FIG. 5A-5B (discussed below) where the thickness of the food blank is determined, and a certain percentage of the food item has a thickness at or below a predefined minimum thickness. In embodiments, where the certain percentage with the thickness at or below the predefined minimum thickness—the final cutting geometry 202 may be decreased to exclude those areas of the food item below minimum thickness. When the certain percentage is above the predefined minimum thickness, the width of the final cutting geometry 202 may be decreased such that the width is less than the maximum width of the pressing machine. Or, as stated herein, the width of the portion could be increased (up to the maximum allowed by pressing machine) until the portion achieves the maximum thickness allowed by the pressing machine as it is pressed.

The cutting strategy may involve two steps as discussed herein, initially identifying a first cutting strategy 102 based purely upon the identified geometry of the food item, and then a step of revising the cutting strategy to a final cutting strategy 202 that takes into account aspects of the food item other than purely the geometry, and takes into account how the size of the bulk cut food item can be modified through the pressing step.

As depicted in FIG. 2, a final cutting strategy 202 is depicted with lines 203 (final front cut), 204 (final left cut), 205 (final right cut), and 206 (final rear cut). This final cutting strategy 202 is determined based upon a consideration of various factors of the food that is observed within the image—with these various factors taken into account to result in a bulk cut portion that will result in cut pieces of saleable size or as desired for further processing that include the most possible yield of the bulk food item initially presented. Some of the items that may be considered to identify the final cutting strategy are as follows which are explained below: difference in geometry from of the bulk food item from a rectangle, areas of high concentration of identified fat, existence of voids included within the initial cutting strategy 102, anticipated density increase when cut food item is pressed, consideration of whether improvement would be possible if final cutting strategy was not a geometric rectangle. These inputs are considered and the relative improvement in the cut food block is determined in order to identify the final cutting strategy 202.

The strategies discussed below, when used to select a final cutting strategy 202 will be readily understand to be technical advantages over the conventional method of identifying the portions of a food block A to be removed to be pressed and cut into individual pieces. These inventive steps (whether used individually, or in combination with some or all of the described steps) allow for better use of the pork belly (for example as the food block A) to be cut so that leaner cuts are established and with less waste of high quality muscle based food within the block. The results that can be achieved with one or more of these steps (based upon the reduction of waste of desirable food within the food block, and leanness of the pieces ultimately cut) is not possible with conventional methods. The steps are also transformative of the operation of the scanning and cutting machine (alone or in conjunction with a pressing machine that receives the cut meat block) because these machines would not be possible to operate in the improved manner without one or more of the steps discussed below. The steps allow for a cutting geometry to be established that is optimized based upon several characteristics that can be optically recognized, which would not be possible by a human operator, and without the machine programed with software that is capable of performing the steps below is not possible based upon the conventional technology.

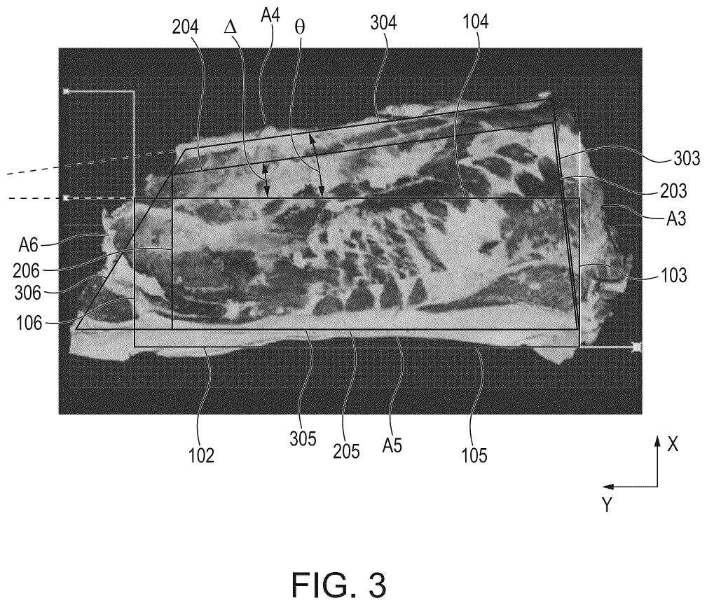

With reference to FIG. 3, the difference in geometry of the bulk food item from a rectangle is determined by comparing the overall shape of the image of the bulk food item (front edge A3, right edge A4, left edge A5, rear edge A6) to a rectangle (i.e. four straight sides and four 90 degree corners). In this process, the system establishes four straight lines (303, 304, 305, 306) that best fit the actual geometry of the bulk food item A. The system then compares the nominal cutting strategy rectangle 102 that is initially positioned upon the bulk food item A, and specifically compares the two identified front sides (103, 303), left sides (104, 304), right sides (105, 305), and rear sides (106, 306). The system identifies whether the two compared sides (e.g. the two right sides 104, 304 as depicted on FIG. 3) and determines the angle Θ between those sides. If the angle Θ between the two exceeds a threshold value, then the system considers selecting the final right side cut (204) to be at an angle A with respect to the initial right side 104. The resulting side at the angle A would be considered to be similar to the geometry of the food block A. In some embodiments, the system may default to selecting the angle A to be equal to the angle Θ, while in other embodiments, the system may select an angle A that is a value less than the angle Θ—such as half the angle Θ, 75% of the angle Θ, 25% of the angle Θ, and the like. One of ordinary skill in the art will be able to select an appropriate percentage of the angle Θ—or a range of possible percentages of the angle Θ (such as between about 25% to about 75% inclusive of all values within the range) with a thorough review and understanding of this specification. This comparison between the nominal line and the image shape line may be performed for only the right and left sides, only the front and back sides, only one of the four sides, or all four of the sides. In this embodiment, the final side selected may not be parallel to the respective typical X or Y direction, i.e. the final front side cut 203 may not be parallel to the X direction, but would still be considered to be the “front side” cut for the purposes of this specification, because it would be the cut surface that would be leading as the food block left the block cutting station, and so on with respect to the right, left, and rear cuts if they are not parallel to the respective X or Y direction.

This step may result in a proposed final cutting strategy 202 that is a shape that is not a geometric rectangle because two or more of the vertices do not establish 90 degree angles. One of ordinary skill in the art will appreciate with a thorough review of this specification, in conjunction with the known understanding of how food items react when pressed by pressing members that are conventionally used for the contemplated food products (e.g. pork bellies), (i.e. how much a pressing machine presses the type of food to be processed by the system) will be able to design a system that can establish a non-geometric rectangle as a shape for the final cutting strategy. Further if the cut food block is cut based upon a final cutting strategy that does not result in a geometric rectangle (with a thickness above the conveyor to make a volume of a cutting block) the pressing the cut food block with a pressing system in each of the X, Y, and Z directions will result in a pressed food block that has sides that are generally perpendicular from the neighboring sides (e.g. front face (along X direction) perpendicular to the left and right sides (along Y direction), etc.).

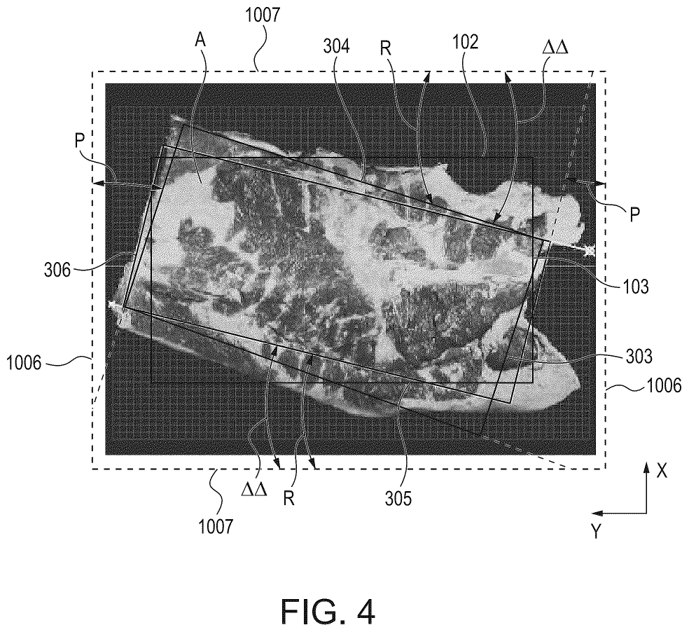

With reference to FIG. 4, may identify or use the four straight lines (303, 304, 305, 306) that best fit the actual geometry of the bulk food item A, as discussed above with reference to FIG. 3. The system may compare P the alignment of one or both of the front and back straight lines (303 and 306) with respect to a line 1006 parallel to the X axis and/or may compare R the alignment of one or both of the right and left straight lines (303, 304) to a line 1007 parallel to the Y axis. If the system determines that both of the right and left lines (304, 305) are offset (angles R) from the line 1007 by at least a threshold angle, then the system determines that the food block A is aligned in an orientation that is offset from the Y axis. A threshold value may be at least about 10%, at least about 15%, at least about 20% or higher percentages than 20% through 45%. Upon making this determination, the system allows the final cutting rectangle 202 to be aligned along the food block A with right and left cutting lines (204, 205) that make an angle AA with respect to the Y axis (or line 1007). The angle AA may be the larger of the two off set angles above the threshold angle, or may be the average of the two off set angles above the threshold angle. In some embodiments, the system may be programmed to reject the food block A from being cut if the offset angle is greater than a certain amount, e.g. 30 degrees. In this embodiment, the system may physically remove the food block A from the system before it is cut. There may be a conveyor that will return the rejected food block to be again aligned with to extend through this visualization module to assess the food block A to be cut in desirably a better alignment with respect to the Y direction.

With reference to FIG. 5, the system may identify areas of high concentration of identified fat (W) or alternatively areas of high concentration of muscle (Z), or both, and/or may identify voids (T) that in the uncut meat block that extend within the initial cutting strategy. The system may move or size the final cutting strategy 202 to attempt to completely or significantly avoid inclusion of voids (T), and may move or size the final cutting strategy 202 to a position to attempt to completely or significantly avoid areas of high concentration of identified fat, especially where the areas of high concentration of identified fat form an outer edge of the food block. FIG. 5 depicts a default cutting rectangle 102 and a final cutting rectangle 202 that is moved to upwardly (as shown on the page, or in the direction of the X axis) to avoid a significant portion of fat (W) that forms the left edge A5 of the food block A. Similarly, FIG. 5 depicts that the same movement of the final cutting rectangle 202 in the X direction also causes the rectangle to no longer include a gap T at the left edge A5 of the food block A. This step can be performed independently, or in conjunction with the step depicted in one or both of FIG. 3 and FIG. 4, discussed above. As depicted further on FIG. 5, the final rear cutting edge 206X may be at an angle to the X axis due to the geometry of the rear surface A6 food block—using the technique discussed with respect to FIG. 3 to take advantage of a larger portion of usable food near the bottom of the meat block (from the perspective of the photograph of the food block A upon the page).

In some embodiments, the system may determine the size of specific voids identified and determine whether the voids are big enough to merit adjusting the cutting strategy to compensate for the void. For example, if the void is very small, it might not be necessary to compensate for the void because the pressing of the food block within the die may reconfigure the food block so that the void no longer exists. If the void is over a certain size—or a certain size as a percentage to the overall size of the food block, then the system may modify the cutting strategy to account for the presence of the void—using one or more of the strategies discussed herein. The size may be measured based upon several methods (i) the actual geometric size of the void (i.e. the area of the void without comparison to the overall size of the food block, (ii) the area of the void when compared to the overall area of the food block, (iii) the volume of negative space within the void when compared to the overall volume of the food block, (iv) the volume of negative space within the void when compared to the volume of food that surrounds the food for a given distance in all directions (i.e. if the void is very small and the surrounding area is very thick the void may be able to be neglected, but if the void is small but the surrounding area is very thin then the void may be important because pressing neighboring thin tissue in the die press may not be able to account for the space left by the void).

Turning now to FIGS. 5A and 5B, an image of the food block X can be obtained that is processed such that the thickness (i.e. the height of the food block above the flat surface that the food block rests upon, or the dimension of the food block along a direction from which the image is oriented on the computer screen or on a paper where it is printed—i.e. out of the computer screen or off of the sheet of paper) is depicted with differing colors or with differing shades of a single color, such as in a greyscale image—lower image in FIG. 5A which is a grayscale height map image based upon thickness of the food item depicted in the upper image on FIG. 5A), the thinnest portions of the food block being depicted with the darkest shade and the thickest portions of the food block being depicted with the lightest shade. For the ease of understanding (and because a grayscale may not print as desired with this specification), FIG. 5B is a schematic annotated drawing that includes symbols that represent different shades of color that represents thickness. In this figure, sections with a “+” symbol are the lightest shade (as would show on a grayscale image—thickest portions), sections with an “@” symbol are the next darker shade, sections with a “#” symbol are the next darker shade (i.e. darker than sections with the @ symbol—darkest on a grayscale image—thinnest portions). In some embodiments, the image may be processed such that the varying shade changes from the lightest shade always being associated with the highest thickness and the lowest thickness being associated with the darkest shade—with the lightest shade always being the same and the darkest shade always being the same. In other embodiments, the image may be processed such that different shades represent specific different thicknesses, such that a certain shade always represents a 0.5 inch thickness, a certain darker shade always represents a 1.0 inch thickness, etc. with the shades between those known thicknesses (as well as above 1.0 inches and below 0.5 inches) being respectively darker or lighter. In this embodiment, the system may be configured to move or define the final cutting rectangle 202 in a similar manner as discussed above with respect to the embodiment of FIG. 5 that discussed modifications in the presence of high fat concentration areas or voids that are along an outer surface. In this embodiment, the system may be programmed to establish the final cutting rectangle 202 to fully or partially avoid the relatively thin areas (i.e. areas of a grayscale (thin) area with a “#” symbol in FIG. 5B of the food block when they are formed along or proximate to one or more of the outer edges of the food block.

In some embodiments, the system may be configured for the system to consider a user inputted minimum thickness level, below which the system attempts to identify the final cutting rectangle 202 to avoid or minimize, and above which the system does not modify the position and size of the final cutting rectangle 202 to avoid or minimize. The system identifies the inputted minimum thickness and determines the shade that represents that thickness on the grayscale image (based upon either grayscale interpretation discussed above) and then identifies the portions of the food block that that have a color that is at the shade or a lighter shade than the determined shade. From this determination, the system determines the position and size of the final cutting rectangle 202 using the steps discussed above.

The system may identify a final cutting rectangle 202 to be sized with a greater length of the front edge (along the X axis, which forms the leading portion of the block as it is cut into individual pieces) than the desired length of the slices to be cut from the meat block. The enlarged cutting rectangle 202 is larger than the final desired length of the front edge, preferably by a percentage of the final desired front edge that the pressing system is known to compact the meat block when pressed. This overage of the final cutting rectangle 202 will result in the desired front edge length (for sale in individual pieces or for future use). This step may be performed independently or in conjunction with the steps of one, two, or all of FIGS. 3-5, discussed above.

Upon completion of the processes described above the system identifies a final cutting plan 202 and transmits the final cutting plan to the cutting apparatus. The final cutting plan may be based upon all of the processes above, and with the position of the cutting lines (203, 204, 205, 206) based upon the processes in different ways. In some embodiments, the system may take the average position of all of the front cutting lines (if adjusted from the nominal front line 103), such as the median average of the possible adjustments to the cutting line, or possibly a straight cutting line that best fits the mean average of all the possible adjustments to the cutting line (mean of x positions along each y value of the line). The other three cutting lines 204, 205, 206 may be established under the same methodology. In other embodiments, the system may establish that if there is a difference between the nominal cutting line (e.g. 103) and one of the modified cutting lines established under one methodology above, but a less difference between other methodologies, the less drastic modification may be adopted.

Finally, after the adjustments to the cutting lines are considered, the system determines the final geometry of the cutting lines and checks that the final geometry will fit within the geometry of the pressing system. If the final cutting lines establish a geometry that is too big (in one or more dimensions) to fit within the pressing system, the system will adjust one or more cutting lines as needed to result in a cut food block that fits within the pressing system.

In an embodiment schematically depicted in FIG. 5C, the system may calculate the volume of the food block that will be cut and compare that volume to the volume of food that can be received within a pressing die that is disposed downstream of the cutting machine and is configured to press the food block after it has been cut in conjunction with the methods discussed herein. The pressing die may involve pressing a food block in up to three of the X, Y, and Z directions. Typically, pressing machines will press a food block in the width direction (direction X) and also either simultaneously or sequentially in the Z direction (perpendicular to both the X and Y directions—i.e. into the page from the perspective of FIG. 1). In some embodiments the pressing machine will not constrain or press the food block in the Y direction, while in other embodiments, the press may have one rigid plate that is either in contact with the front end of the food block or the rear end of the food block, but will allow the food block to expend in the Y direction as the food block is pressed in the X direction and also sometimes the Z direction. Accordingly, the die presses the food block into a predetermined width and presses the food block (if necessary) in the Z direction to a predetermined thickness. In some embodiments, the food block may have an initial thickness that is less than a desired final thickness, and due to the initial pressing in the X direction the thickness of the food block may expend in the Z direction. The die may have a top plate that is set at the overall desired final thickness of the food block to limit the expansion of the thickness. In some embodiments, the top plate may be initially set above the level of the desired thickness to allow the food block to expand, and then the top plate of the die may press downwardly (Z direction) to compress the thickness of the food block to the desired final thickness. This alternative procedure may result in a food block with a more uniform thickness along its area than the initial procedure where the top plate is initially set at the desired thickness.

In this embodiment, the system may identify the thickness of the food block throughout its area (5001)—either by examining an image that is calibrated for thickness (as discussed above) or both alternatively scanning the height of the food block via other methods.

The system may include a programmed set point or a user defined set point for a minimum food thickness, which is a minimum desired thickness of the food block (5002) The system may compare the identified thicknesses from the area of the food block with the established set point for the minimum food thickness and identify any areas where the food block is not as thick as the minimum food thickness (5003). If the food block has one or more areas where the identified thickness is less than the minimum food thickness, the system may move cutting rectangle within the food block to avoid or minimize the presence of areas where the identified thickness is less than the minimum food thickness—using one or more of the methods discussed herein to alter the position, size, and orientation of the area to be cut (5004).

For example, if it is determined that areas where the measured thickness of the food block that are less than the minimum food thickness that are bordering or proximate to one of the outer edges of the food block (e.g. the outer right edge), the system may move the final cutting geometry within the food block that is away from the areas that are less than the minimum food thickness (e.g. move the lines of cutting to establish the final cutting geometry away from the outer right edge).

In some embodiments as schematically depicted in FIG. 5D, the method may include identifying the average overall thickness of the food block and the average width and the average length of the food block to determine the volume averaged food block (6001). This method may be conducted before the cutting strategy is developed and then again of the food block that is within remaining food block after the cutting strategy is completed.

The average volume of the food block (both initial and final) are compared with a volume of the die of the pressing machine (i.e. the volume between the X, Y, and Z pressing members, or the combination of pressing members and fixed members in the X, Y, and Z directions (6002). The method also includes comparing the average width of the food block with the maximum width of the die, as well as comparing the maximum width of the food block (i.e. the maximum width of the volume of the food block that remains after the strategic left and right cuts are made to the food block) with the maximum width of the die.

The method further includes comparing the calculated average volume of the food block with the volume of the die pressing machine. If the volume of the calculated volume of the food block is greater than the volume of the die pressing machine, the system identifies (from the image and one or more of the strategies for placement of the cuts discussed above) the possible front end cut, possible right side cut, possible left side cut, and possible rear side cut in order to result in a volume of cut food that is equal to or as close as possible to but just below the volume of the die—based upon the average thickness of the food block within the area of the food block within the front, right, left, and rear cuts as determined (6003).

The system further identifies the width of the food block based upon the cutting strategy determined immediately above and compares that width with the width of the pressing die (6004). If the width of the food block based upon the cutting strategy is less than the width of the pressing die, the system may increase the width of the food block post-cut by moving one or both of the right and left side cuts of the final cutting strategy outward to equal to or just be just smaller than the width of the cutting die (6005). This has the benefit of allowing more volume of the food block to be saved after the cuts and to allow for more of the food block to be compressed. This method step is especially applicable when the die does not constrain the length of the food block—i.e. the food block is allowed to expand in length after it is pressed in the X and the Z directions—which will result in a somewhat longer pressed food—but with a cross-section that approaches the cutter (i.e. in the X, Z plane) to be maximized and closest to the X, Z area allowed by the die as possible.

This method of preparing the food block and be used with one or more of the following strategies—discussed above:
a. identifying a difference in the geometry of the food item from the identified rectangle and adjusting the final cutting geometry to align one or more of the final cut sides to be similar to the geometry of the food item;
b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
c. identify if the food block includes any areas of high concentration of fat and adjusting the final cutting geometry to an area that avoids the identified high concentration of fat as possible; and
d. identify if the food block includes any voids within the area enclosed by the identified rectangle above a certain area or volume or above a certain proportion of a total area or volume of the food block, and adjust the final cutting geometry to an area that avoids the identified voids.

In some embodiments as depicted schematically in FIG. 5E, the methods discussed above, may be used in conjunction with a pre-programed or a user selected percent die fill threshold. The percent die fill is a define percentage of an allowable pre-pressed food volume to be presented to the die (7001) with respect to the maximum volume that the die can receive (as constrained by a maximum width of food that the die can receive, a maximum thickness of food that the die can receive, and when applicable a maximum length of the food that the die can receive.

The percent die fill is the ratio of volume of food block presented to the die to the maximum volume of the food that the die can receive. In situations when a percent die fill threshold is applicable (7003) (i.e. a user of the machine that operates in conjunction with one or more of the methods discussed here—with a percent die fill) the system may identify the optimized cutting strategy for the food block using one or multiple of the strategies for establishing the placement of the cutting lines discussed above, and then identifies the ratio of die fill (7002), and compares that ratio to the percent die fill (7004). If the percent die fill is less than 100 and is also less than the determined ratio, then the system will reduce the size of the cutting block that is cut (using one or more of the methods for establishing the food cuts discussed above) and sent to the die until the volume of the cut food block—when compared to the volume of the die—results in the required percent die fill (7005). On the other hand, if the percent die fill is more than 100, then the system will increase the size of the cutting block that is cut (using one or more of the methods for establishing the food cuts discussed above and sent to the die until the volume to be sent to the die—when compared to the volume of the die results in the required percent die fill (7006)). In this alternative, the size of the food block after the cutting strategy is constrained by the maximum width of the die and, if applicable, the maximum thickness of the die—and the system makes the cutting strategy in view of the width and possibly the thickness constraints using the method as discussed above. In some embodiments, the system may be programmed with the maximum percent die fill for a given food being processed, i.e. maximum die fill of 108% for beef, 110% for pork, 118% for chicken (these numbers are only examples one of ordinary skill in the art could determine the actual maximum die fill by testing each type of food for the ability of the food (at volumes typical of bulk foods to be processed—e.g. at the size of a typical chicken breast, or a typical pork belly) of how much “play” the bulk meat has to be rearranged when under pressure of the die so that excess meat in the width direction can be urged in the Z (thickness direction) to more fill up the rectangular cross-section of the die. The play of the specific food is something that is believed to be easily determined via testing and therefore one of ordinary skill in the art would be able to determine a specific maximum die fill for different foods (and different starting sizes of each food) with merely routine testing and optimization. In this embodiment, the pre-programmed percent die fill may be used for the system with knowledge of the type of food being processed and the size of the starting block being processed.

Additionally or alternatively, the system may identify a maximum width proportion with respect to the width of the die that will receive the cut food block. The maximum width proportion may be maximum width of the cut food block in comparison to the width of the die. The maximum width proportion allows for the width of the final cutting strategy 202 to be somewhat larger than the width of the die press, or a certain proportional increase over the width of the die. The maximum width proportion may be determined by the user, or it may be programmed into the system such that the user has no control over the maximum width proportion, other than such as to turn on or turn off the maximum width proportion. The maximum width proportion may be determined in a similar manner to the determination of the percent die fill as discussed above, such as experimentally after a thorough review of this specification and in determining the material properties of typical foods that will be used with the system—as with the above. The maximum width proportion may be on the order of 105%, 110%, 115%, 120% or other values similar to these values, or potentially higher after via testing of samples of the various food blocks that are anticipated to be used with the system.

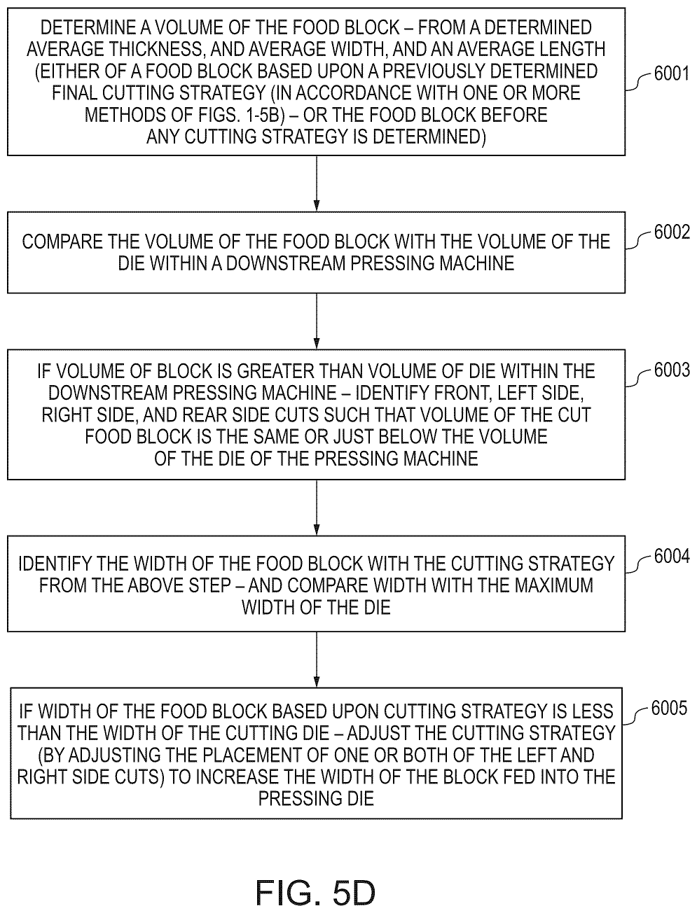

Referring to FIG. 6, there is a processing system 600 for cutting food blocks according to an embodiment using one or more of the cutting strategies described herein. In the embodiment shown, the system 600 includes a computing device 602, one or more imaging devices 604, and one or more electronically-controlled cutting devices 606. The computing device 602 is programmed to determine a cutting strategy based on imaging data of food block A from the one or more imaging devices 604, and communicates cutting commands to the one or more electronically-controlled cutting devices 606, as described herein. In the embodiment shown, the computing device 602 communicates with the one or more imaging devices 604 and one or more electronically-controlled cutting devices 606 over a network 607.

The computing device 602 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. As shown in FIG. 6, the computing device 602 illustratively includes a processor 608, an input/output subsystem 610, a memory 612, a data storage device 614, a communication subsystem 616, and/or other components and devices commonly found in a computer or similar computing device. Of course, the computing device 602 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 612, or portions thereof, may be incorporated in the processor 608 in some embodiments.

The processor 608 may be embodied as any type of processor capable of performing the functions described herein. The processor 608 may be a multi-core processor or in other embodiments the processor 608 may be embodied as a single or multi-core processor(s), digital signal processor, microcontroller, or other processor or processing/controlling circuit. Although illustrated as including a single processor 608, in some embodiments the computing device 602 may be embodied with multiple processors.

The memory 612 may be embodied as any type of volatile or non-volatile memory or data storage capable of performing the functions described herein. In operation, the memory 612 may store various data and software used during operation of the computing device 602 such operating systems, applications, programs, libraries, and drivers. The memory 612 is communicatively coupled to the processor 608 via the I/O subsystem 610, which may be embodied as circuitry and/or components to facilitate input/output operations with the processor 608, the memory 612, and other components of the computing device 602. For example, the I/O subsystem 610 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 610 may form a portion of a system-on-a-chip (SoC) and be incorporated, along with the processor 608, the memory 612, and other components of the computing device 602, on a single integrated circuit chip. Similarly, the data storage device 614 may be embodied as any type of device or devices configured for short-term or long-term storage of data such as, for example, memory devices and circuits, memory cards, hard disk drives, solid-state drives, non-volatile flash memory, or other data storage devices.

In some embodiments, the computing device 602 also includes the communication subsystem 616, which may be embodied as any communication circuit, device, or collection thereof, capable of enabling communications between the computing device 602 and other remote devices, such as the imaging device(s) 604 and/or the cutting device(s) 606, over the computer network 607. For example, the communication subsystem 616 may be embodied as or otherwise include a network interface controller (NIC) 618 or other network controller for sending and/or receiving network data with remote devices. The NIC 618 may be embodied as any network interface card, network adapter, host fabric interface, network coprocessor, or other component that connects the computing device 602 to the network 607. The communication subsystem 616 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication. In some embodiments, the communication subsystem 616 may form a portion of an SoC and be incorporated along with the processor 608 and other components of the computing device 602 on a single integrated circuit chip.

The computing device 602 may further include one or more peripheral devices 620. The peripheral devices 620 may include any number of additional input/output devices, interface devices, and/or other peripheral devices. For example, in some embodiments, the peripheral devices 620 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

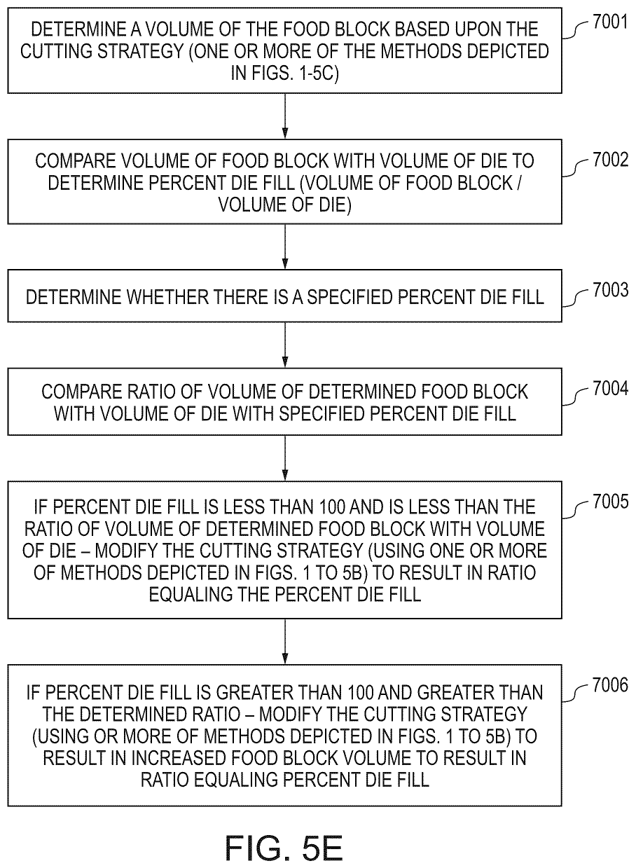

Referring now to FIG. 7, in an illustrative embodiment, the computing device 602 establishes an environment 700 during operation to control cutting of a food block A. The illustrative environment 700 includes an imaging data ingestion manager 702, an image analysis engine 704, a cutting geometry determination engine 706, and a cutting device(s) movement controller 708. As shown, the various components of the environment 700 may be embodied as hardware, firmware, software, or a combination thereof. As such, in some embodiments, one or more of the components of the environment 700 may be embodied as circuitry or collection of electrical devices (e.g., imaging data ingestion circuitry 702, an image analysis circuitry 704, a cutting geometry determination circuitry 706, and a cutting device(s) movement controller circuitry 708). It should be appreciated that, in such embodiments, one or more of the imaging data ingestion manager 702, an image analysis engine 704, a cutting geometry determination engine 706, and a cutting device(s) movement controller 708 may form a portion of the processor 608, the NIC 618, the I/O subsystem 610, and/or other components of the computing device 602. Additionally, in some embodiments, one or more of the illustrative components may form a portion of another component and/or one or more of the illustrative components may be independent of one another.

The imaging data ingestion manager 702 is configured to receive image data of the food block A from the one or more imaging devices. As discussed herein, the image data could be embodied as any data representing the food block A, such as photographic image data, x-ray image data, greyscale image data, data from sensors that represent the food block A with wavelengths not visible to the human eye, ultrasound image data, or the like. In some embodiments, the imaging data ingestion manager 702 receives real-time image data as the food block A travels in the processing system.

The image analysis engine 704 is configured to analyze the imaging data of the food block A to determine one or more characteristics about the food block A. As discussed herein, the image analysis engine 704 can identify certain anatomic features or characteristics about the food block A. There are a variety of anatomic features that can be detected by the image analysis engine 704.

In some embodiments, the image analysis engine 704 could include an anatomic feature identification feature 710 that is configured to identify one or more anatomic features of the food block A. By way of example only, the image analysis engine 704 may be configured to determine the position of (and the concentration) of portions that are determined to be primarily muscle (e.g. typically the darker portions on a greyscale image) and primarily fat (e.g. typically the lighter portions on a greyscale image).

In some embodiments, the image analysis engine 704 may include an anatomic landmark identification feature 712 that is configured to identify the position of certain identifiable anatomic landmarks within the food item, as well as the size of the anatomic landmarks within the food item. By way of example only, the anatomic landmark identification feature may be configured identify the left side portion and the right side portion of the food block. This could be technically advantageous because, in the context of the food block being embodied as a pork belly, identifying whether the pork belly is cut from the left side or the right side could instruct on which side is more lean (spine side) versus the more fatty side (belly side). Depending on the circumstances, the image analysis engine 704 could be configured to identify the CT muscle and/or the bootjack of a pork belly based on striations in the image to determine the left side and right side. In some embodiments, the image analysis engine 704 may include machine learning capabilities to identify anatomic landmarks. For example, the image analysis engine 704 may include one or more machine learning models that have been trained to identify anatomic landmarks of the food block A. By way of example, the image analysis engine 704 may include a CT muscle model and/or a bootjack model that are configured to use machine learning to identify the position of the CT muscle and/or the bootjack model, respectively.

The cutting geometry determination engine 706 is configured to determine a cutting strategy based on the analysis from the image analysis engine 704, and the objectives of the cutting strategy, such whether to prioritize a large cut, a lean cut, etc. For example, the cutting strategy may represent a geometric shape of cutting paths to cut the food block A. By way of example only, the geometric shape could be a rectangle, square, polygon or other shapes along which the food block A will be cut. In some cases, as discussed herein, the geometric shape may be rotated with respect to a longitudinal axis along which the food A travels through the processing system depending on the circumstances.

As discussed herein, the cutting geometry determination engine 706 may determine an initial cutting strategy 714, such as a geometric shape based on the outer periphery of the food block. For example, the initial cutting strategy 714 could be a rectangular shape sized to surround the periphery of the food block A. In some cases, the cutting geometry determination engine 706 may then determine a final cutting strategy 716. For example, the final cutting strategy may adjust or modify the initial cutting strategy to change the initial strategy for the cutting paths of the cutting devices. For example, the final cutting strategy may adjust the cutting paths to maximum lean meat of the food item.

Consider an example in which the cutting geometry determination engine 706 is configured to select the leanest portion of the food block A. In this example, the cutting geometry determination engine 706 may determine an initial cutting strategy to be a rectangle with a width of W and a length of L, where W and L are based on the size of the outer periphery of the food block A as determined by the image analysis engine 704. The cutting geometry determination engine 706 may then determine a final cutting strategy in which it selects a smaller geometric shape within the initial rectangular shape based the image analysis engine 704 determination of which portion has the leanest meat. In some embodiments, for example, the cutting geometry determination engine 706 may calculate a lean parameter for a plurality of geometric shapes within the initial rectangular shape and determine which of those smaller geometric portions of the food block A contains the leanest portion of meat.

The cutting device(s) movement controller 708 is configured to send control instructions to the electronically-controlled cutting device(s) 606 with cutting paths for cutting the food block A based on the cutting strategy determined by the cutting geometry determination engine 706. The control instructions will control the cutting device(s) so that the food block A is cut into a shape as determined by the cutting strategy.

Referring now to FIG. 8, in use, the computing device 602 may execute a method 800 for cutting a food block A. In the embodiment shown, the method 800 starts with block 802 in which the computing device 602 receives imaging data of a food block A from the one or more imaging devices 604. The method 800 advances to block 804 in which the imaging data is analyzed to determine one or more characteristics of the food block A. As discussed herein, the image analysis may include anatomic feature identification 806, which may be configured to identify which portions of the food block are the leanest or other characteristics. In some embodiments, the image analysis may include anatomic landmark identification 808, which may be configured to identify particular anatomic landmarks, such as a CT muscle and/or a bootjack in an example in which the food block is a pork belly. The method 800 proceeds to block 810 in which a cutting strategy is determined. As discussed herein, in some cases, there is an initial cutting strategy 812 determined, which may be modified or adjusted into a final cutting strategy 814 based on certain cutting priorities or parameters. The cutting strategy, in some embodiments, sets forth geometric paths for the cutting device(s) 606 to take to cut the food block. The method 800 then advances to block 816 in which the computing device 602 sends instructions to the cutting device(s) 606 with the cutting paths to cut the food block.

The term “about” is specifically defined herein to include a range that includes the reference value and plus or minus 5% of the reference value. The term “substantially the same” is satisfied when the width of the end surfaces of the holes are both within the above range.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be understood with reference to the following Representative Paragraphs:

Representative Paragraph 1: A method to cut a food block, comprising
preparing an image of a food block, the food block provided within a system that is adapted to cut the food block into a size that is desired for sale, and in some embodiments for cutting into multiple smaller salable pieces;
identifying a rectangle for cutting a block of meat within a projection of the food block within the image, wherein the rectangle includes a possible front end cut, a possible right side cut, a possible left side cut, and a possible rear side cut;
considering adjustments to the size of the rectangle based upon one or more identifiable aspects of the food block from the image, and establishing a final cutting geometry with a final front end cut, final right side cut, final left side cut, and final rear side cut,
wherein the method includes one or more of the following possible adjustments:
   a. identifying a difference in the geometry of the food item from the identified rectangle and adjusting the final cutting geometry to align one or more of the final cut sides to be similar to the geometry of the food item;
   b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
   c. identify if the food block includes any areas of high concentration of fat and adjusting the final cutting geometry to an area that avoids the identified high concentration of fat as possible; and
   a. d. identify if the food block includes any voids within the area enclosed by the identified rectangle above a certain area or volume or above a certain proportion of a total area or volume of the food block, and adjust the final cutting geometry to an area that avoids the identified voids.

Representative Paragraph 2: A method to cut a food block, comprising
preparing an image of a food block, the food block provided within a system that is adapted to cut the food block into a size that is desired for sale, and in some embodiments for cutting into multiple smaller salable pieces;
identifying a rectangle for cutting a block of meat within a projection of the food block within the image, wherein the rectangle includes a possible front end cut, a possible right side cut, a possible left side cut, and a possible rear side cut;
considering adjustments to the size of the rectangle based upon one or more identifiable aspects of the food block from the image, and establishing a final cutting geometry with a final front end cut, final right side cut, final left side cut, and final rear side cut.

Representative Paragraph 2.1. The method of either of Representative Paragraphs 1 or 2, wherein the image is a photographic image.

Representative Paragraph 2.2. The method of either of Representative Paragraphs 1 or 2, wherein the image is a composite of a plurality of images made of a respective plurality of neighboring sections of the food block that are sequentially prepared as the food block moves based past a sensing position, wherein each of the plurality of images of neighboring sections are positioned adjacent to each other on a single image to represent an image of the entire food block.

Representative Paragraph 3: The method of any one of Representative Paragraphs 1-2.2, wherein the method includes the adjustment of identifying a difference in the geometry of the food item from the identified rectangle and adjusting the final cutting geometry to align one or more of the final cut sides to be similar to the geometry of the food item.

Representative Paragraph 4: The method of Representative Paragraph 3, further comprising establishing straight lines that best fit the actual geometry of food block, the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines.

Representative Paragraph 5: The method of Representative Paragraph 4, further comprising comparing the second straight line with a line of the identified rectangle that is closest to the second straight line and identifying a second angle therebetween, and
comparing the fourth straight line with a line of the identified rectangle that is closest to the fourth straight line and identifying a fourth angle therebetween;
comparing the second angle and the fourth angle individually to a predetermined threshold angle;
if either the second angle or the fourth angle is larger than the predetermined threshold angle, for one or both of the right or left sides if larger than the predetermined threshold angle, establishing the respective final right side cut and/or the respective left side cut that is equal to or less than the predetermined threshold angle.

Representative Paragraph 6: The method of Representative Paragraph 4, further comprising comparing one of (i) the second straight line with the possible left side cut and identifying a second angle therebetween, and
(ii) the fourth straight line with the possible right side cut and identifying a fourth angle therebetween;
comparing the chosen second angle or the fourth angle to a predetermined threshold angle;
if the chosen second angle or fourth angle is larger than the predetermined threshold angle, establishing the respective final right side cut or the respective left side cut at an orientation that is equal to the predetermined threshold angle or at an angle with respect to the respective possible left side cut or the possible right side cut that is less than the predefined threshold angle.

Representative Paragraph 7: The method of Representative Paragraph 6, wherein the method includes the adjustment of identifying if the food block is oriented such that both left and right side surfaces are offset from the Y axis, which is an axis about parallel to typical and left and right side surfaces, above a certain threshold value, and if above the certain threshold value, adjusting the angle of the final cutting lines to establish a cutting rectangle based upon this offset.

Representative Paragraph 8: The method of Representative Paragraph 7, further comprising establishing straight lines that best fit the actual geometry of the food block, wherein the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines,
further comprising comparing both of the second straight line and the fourth straight lines with a line (1007) that is parallel to a Y-axis of a coordinate system set up such that the Y-axis is a direction between the front and rear end surfaces of the rectangle and an X-axis is a direction parallel to the front and rear end surfaces of the rectangle and determining a differential angle between each of the respective second straight line and the fourth straight line and the line parallel to the Y-axis.

Representative Paragraph 9: The method of Representative Paragraph 8,
wherein if the comparison between both of the second and fourth straight lines with the line that is parallel to the Y-axis of the coordinate system results in both of the differential angles being greater than a threshold valve, determining that the food block is set up in an orientation that is offset from the Y axis;
wherein upon the determination that both of the differential angles are greater than the threshold value by a predetermined amount, physically removing the food block from the system to allow the food block to be at a later time to be repositioned to allow for again preparing an image of the food block.

Representative Paragraph 10: The method of Representative Paragraph 8, wherein if the comparison between both of the second and fourth straight lines with the line that is parallel to the Y-axis of the coordinate system results in both of the differential angles being greater than a threshold valve, determining that the food block is set up in an orientation that is offset from the Y-axis, and establishing the final cutting geometry such that the final left side cut and the final right side cuts are each along parallel lines that are at an angle with respect to the Y-axis.

Representative Paragraph 11: The method of Representative Paragraph 10, wherein the final left side cut and the final right side cut are along lines that are parallel to the one of the second or fourth straight lines that was at a larger differential angle.

Representative Paragraph 12: The method of Representative Paragraph 10, wherein the final left side cut and the final right side cut are along lines that are parallel to a line that is at an angle that is equal to the average of the differential angle established with the second straight line and the Y-axis and the differential angle established with the fourth straight line and the Y-axis.

Representative Paragraph 13: The method of any one of Representative Paragraphs 1-12, wherein the method includes the adjustment of identifying if the food block includes any areas of high concentration of fat and adjusting the final cutting geometry to an area that avoids this high concentration of fat as possible.

Representative Paragraph 14: The method of Representative Paragraph 13, further comprising identifying in the image the portions of the food block that exhibit a high concentration of fat by identifying portions of the a first certain predetermined image quality than remaining portions of the food block that exhibit second or other certain predetermined image qualities,
wherein from the identified portions of the food block that exhibit the high concentration of fat and when those identified portions are proximate to a right side edge or a left side edge of the food block, moving the rectangle for cutting the block in a direction parallel to a Y-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

Representative Paragraph 15: The method of either of Representative Paragraphs 13 or 14, further comprising identifying in the image the portions of the food block that exhibit a high concentration of fat by identifying portions of the image that are of lighter color than remaining portions of the food block,
wherein from the identified portions of the food block that exhibit the high concentration of fat and when those identified portions are proximate to a front side edge or a rear side edge of the food block, moving the rectangle for cutting the block in a direction parallel to a X-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

Representative Paragraph 16: The method of any one of Representative Paragraphs 1-15, further comprising identifying if the food block includes any voids within an area enclosed by the identified rectangle above a certain area or volume or above a certain proportion of a total area or volume of the food block, and adjust the final cutting geometry to an area that avoids the identified voids.

Representative Paragraph 17: The method of Representative Paragraph 16, further comprising identifying portions of the food block that exhibit the void in the image,
wherein from the identified portions of the food block that exhibit void and when those identified portions are proximate to a right side edge or a left side edge of the food block, moving the rectangle for cutting the block in a direction parallel to a Y-axis of a coordinate plane such that the rectangle no longer covers a significant portion of the void, wherein the Y-axis is a direction between the front and rear end surfaces of the rectangle and the X-axis is a direction parallel to the front and rear end surfaces of the food block.

Representative Paragraph 18: The method of either one of Representative Paragraphs 16 or 17, further comprising identifying the locations on the food block the locations that have a void by identifying portions of food block that do not have the image quality as they would if food block existed at that portion,
wherein from the identified portions of the food block that exhibit a void and when those identified portions are proximate to a front side edge or a rear side edge of the food block, moving the rectangle for cutting the block in a direction parallel to an X-axis of a coordinate plane such that the rectangle no longer covers a significant portion void, wherein the Y-axis is a direction between the front and rear end surfaces of the rectangle and the X-axis is a direction parallel to the front and rear end surfaces of the food block.

Representative Paragraph 19: The method of any one of Representative Paragraphs 1-18, wherein the method includes determining whether there is a minimum food thickness specified and if the minimum food thickness is specified, determining areas upon the food block where the measured thickness is less than the minimum food thickness, if the food block has any areas of food thickness that are below a minimum thickness level adjusting the final cutting geometry within the food block to a geometry and position that avoids as much of the food block with thickness less than the minimum food thickness as is possible.

Representative Paragraph 20: The method of Representative Paragraph 19, wherein if the determined areas upon the food block where the measured thickness is less than the minimum food thickness are along or proximate to an outer edge of the food block, moving the final cutting geometry in a direction away from the outer edge of the food block that includes the measured thickness that is less than the minimum food thickness.

Representative Paragraph 21: The method of either one of Representative Paragraphs 1 or 2, the step of establishing the final cutting geometry further comprises identifying a thickness of the food block,
calculating a volume of the food block;
comparing the calculated volume of the food block with a maximum die volume for receipt of food blocks within a die of a pressing machine that is disposed to receive the cut food block,
identifying a maximum width within the die;
identifying the rectangle for cutting the food block within the image with a possible front end cut, a possible right side cut, a possible left side cut, and a possible rear side cut positioned to establish a cut food block volume that is one of equal to the maximum die volume or as close as possible to the maximum die volume based upon the volume of the food block within an area bounded by the rectangle for cutting the food block, wherein a distance between the possible left side cut and the possible right side cut is equal to or as close as possible to the maximum width within the die.

Representative Paragraph 22: The method of Representative Paragraph 21, wherein the method includes one or more of the following possible adjustments:
a. identifying a difference in the geometry of the food item from the identified rectangle and adjusting the final cutting geometry to align one or more of the final cut sides to be similar to the geometry of the food item;
b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
c. identify if the food block includes any areas of high concentration of fat and adjusting the final cutting geometry to an area that avoids the identified high concentration of fat as possible; and
d. identify if the food block includes any voids within the area enclosed by the identified rectangle above a certain area or volume or above a certain proportion of a total area or volume of the food block, and adjust the final cutting geometry to an area that avoids the identified voids.

Representative Paragraph 23: The method of Representative Paragraph 21, identifying whether there is an established percent die fill of the pressing machine, wherein the percent die fill is a reduction or an increase of a volume of the food block with respect to maximum die volume;
wherein if the percent die fill is a percentage less than 100, reducing the size of the rectangle for cutting the food block such that a ratio of the reduced cut food block volume to the initially calculated food block volume will equal the percent die fill; and
wherein if the percent die fill is a percentage greater than 100, increasing the size of the rectangle for cutting the food block such that the ratio of the increased cut food block volume to the initially calculated food block volume will equal the percent die fill.

Representative Paragraph 24: A method to cut a food block, comprising
determining a geometry of a food block, as well as determining any areas of a high concentration of fat based upon observation of an outer top surface of the food block, and coordinating any observed locations of high concentration of fat with the determined geometry of the food block, the food block provided within a system that is adapted to cut the food block into a size that is desired for sale, and in some embodiments for cutting into multiple smaller salable pieces;
preparing an image that is representative of the geometry of the food block and includes any observed areas of high concentration of fat;
identifying a rectangle for cutting a block of meat upon the image, wherein the rectangle includes a possible front end cut, a possible right side cut, a possible left side cut, and a possible rear side cut;
considering adjustments to the size of the rectangle based upon one or more identifiable aspects of the food block from the image, and establishing a final cutting geometry with a final front end cut, final right side cut, final left side cut, and final rear side cut,
wherein the method includes one or more of the following possible adjustments:
   a. identifying a difference in the geometry of the food item from the identified rectangle and adjusting the final cutting geometry to align one or more of the final cut sides to be similar to the geometry of the food item;
   b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
   c. identify if the food block includes any areas of high concentration of fat and adjusting the final cutting geometry to an area that avoids the identified high concentration of fat as possible; and
   d. identify if the food block includes any voids within the area enclosed by the identified rectangle above a certain area or volume or above a certain proportion of a total area or volume of the food block, and adjust the final cutting geometry to an area that avoids the identified voids.

Representative Paragraph 25: The method of Representative Paragraph 24, wherein the image is a composite of a plurality of images made of a respective plurality of neighboring sections of the food block that are sequentially prepared as the food block moves based past a sensing position, wherein each of the plurality of images of neighboring sections are positioned adjacent to each other on a single image to represent an image of the entire food block.

Representative Paragraph 25.1: The method of either of Representative Paragraph 24, wherein the image is a photographic image.

Representative Paragraph 26: The method of any one of Representative Paragraphs 24-25.1, wherein the method includes the adjustment of identifying a difference in the geometry of the food item from the identified rectangle and adjusting the final cutting geometry to align one or more of the final cut sides to be similar to the geometry of the food item.

Representative Paragraph 27: The method of Representative Paragraph 26, further comprising establishing straight lines that best fit the actual geometry of food block, the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines.

Representative Paragraph 28: The method of Representative Paragraph 27, further comprising comparing the second straight line with a line of the identified rectangle that is closest to the second straight line and identifying a second angle therebetween, and
comparing the fourth straight line with a line of the identified rectangle that is closest to the fourth straight line and identifying a fourth angle therebetween;
comparing the second angle and the fourth angle individually to a predetermined threshold angle;
   if either the second angle or the fourth angle is larger than the predetermined threshold angle, for one or both of the right or left sides if larger than the predetermined threshold angle, establishing the respective final right side cut and/or the respective left side cut that is equal to or less than the predetermined threshold angle.

Representative Paragraph 29: The method of Representative Paragraph 27, further comprising comparing one of (i) the second straight line with the possible left side cut and identifying a second angle therebetween, and
(ii) the fourth straight line with the possible right side cut and identifying a fourth angle therebetween;
comparing the chosen second angle or the fourth angle to a predetermined threshold angle;
if the chosen second angle or fourth angle is larger than the predetermined threshold angle, establishing the respective final right side cut or the respective left side cut at an orientation that is equal to the predetermined threshold angle or at an angle with respect to the respective possible left side cut or the possible right side cut that is less than the predefined threshold angle.

Representative Paragraph 30: The method of Representative Paragraph 29, wherein the method includes the adjustment of identifying if the food block is oriented such that both left and right side surfaces are offset from the Y axis, which is an axis about parallel to typical and left and right side surfaces, above a certain threshold value, and if above the certain threshold value, adjusting the angle of the final cutting lines to establish a cutting rectangle based upon this offset.

Representative Paragraph 31: The method of Representative Paragraph 30, further comprising establishing straight lines that best fit the actual geometry of the food block, wherein the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines, further comprising comparing both of the second straight line and the fourth straight lines with a line (1007) that is parallel to a Y-axis of a coordinate system set up such that the Y-axis is a direction between the front and rear end surfaces of the rectangle and an X-axis is a direction parallel to the front and rear end surfaces of the rectangle and determining a differential angle between each of the respective second straight line and the fourth straight line and the line parallel to the Y-axis.

Representative Paragraph 31: The method of Representative Paragraph 30,
wherein if the comparison between both of the second and fourth straight lines with the line that is parallel to the Y-axis of the coordinate system results in both of the differential angles being greater than a threshold valve, determining that the food block is set up in an orientation that is offset from the Y axis;
wherein upon the determination that both of the differential angles are greater than the threshold value by a predetermined amount, physically removing the food block from the system to allow the food block to be at a later time to be repositioned to allow for again preparing an image of the food block.

Representative Paragraph 32: The method of Representative Paragraph 30, wherein if the comparison between both of the second and fourth straight lines with the line that is parallel to the Y-axis of the coordinate system results in both of the differential angles being greater than a threshold valve, determining that the food block is set up in an orientation that is offset from the Y-axis, and establishing the final cutting geometry such that the final left side cut and the final right side cuts are each along parallel lines that are at an angle with respect to the Y-axis.

Representative Paragraph 33: The method of Representative Paragraph 32, wherein the final left side cut and the final right side cut are along lines that are parallel to the one of the second or fourth straight lines that was at a larger differential angle.

Representative Paragraph 34: The method of Representative Paragraph 32, wherein the final left side cut and the final right side cut are along lines that are parallel to a line that is at an angle that is equal to the average of the differential angle established with the second straight line and the Y-axis and the differential angle established with the fourth straight line and the Y-axis.

Representative Paragraph 35: The method of any one of Representative Paragraphs 24-34, wherein if the food block includes any areas of high concentration of fat and adjusting the final cutting geometry to an area that avoids this high concentration of fat as possible.

Representative Paragraph 36: The method of Representative Paragraph 35, wherein from the identified portions of the food block that exhibit the high concentration of fat and when those identified portions are proximate to a right side edge or a left side edge of the food block, moving the rectangle for cutting the block in a direction parallel to a Y-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

Representative Paragraph 37: The method of either of Representative Paragraphs 35 or 36, wherein from the identified portions of the food block that exhibit the high concentration of fat and when those identified portions are proximate to a front side edge or a rear side edge of the food block, moving the rectangle for cutting the block in a direction parallel to a X-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

Representative Paragraph 37: The method of any one of Representative Paragraphs 24-36, further comprising identifying if the food block includes any voids within an area enclosed by the identified rectangle above a certain area or volume or above a certain proportion of a total area or volume of the food block, and adjust the final cutting geometry to an area that avoids the identified voids.

Representative Paragraph 38: The method of Representative Paragraph 37 wherein from the identified portions of the food block that exhibit void and when those identified portions are proximate to a right side edge or a left side edge of the food block, moving the rectangle for cutting the block in a direction parallel to a Y-axis of a coordinate plane such that the rectangle no longer covers a significant portion of the void, wherein the Y-axis is a direction between the front and rear end surfaces of the rectangle and the X-axis is a direction parallel to the front and rear end surfaces of the food block.

Representative Paragraph 39: The method of either one of Representative Paragraphs 37 or 38, further comprising identifying the locations on the food block the locations that have a void by identifying portions of food block that do not have the image quality as they would if food block existed at that portion,
wherein from the identified portions of the food block that exhibit a void and when those identified portions are proximate to a front side edge or a rear side edge of the food block, moving the rectangle for cutting the block in a direction parallel to an X-axis of a coordinate plane such that the rectangle no longer covers a significant portion void, wherein the Y-axis is a direction between the front and rear end surfaces of the rectangle and the X-axis is a direction parallel to the front and rear end surfaces of the food block.

Representative Paragraph 40: The method of any one of Representative Paragraphs 24-39, wherein the method includes determining whether there is a minimum food thickness specified and if the minimum food thickness is specified, determining areas upon the food block where the measured thickness is less than the minimum food thickness, if the food block has any areas of food thickness that are below a minimum thickness level adjusting the final cutting geometry within the food block to a geometry and position that avoids as much of the food block with thickness less than the minimum food thickness as is possible.

Representative Paragraph 41: The method of Representative Paragraph 40, wherein if the determined areas upon the food block where the measured thickness is less than the minimum food thickness are along or proximate to an outer edge of the food block, moving the final cutting geometry in a direction away from the outer edge of the food block that includes the measured thickness that is less than the minimum food thickness.

Representative Paragraph 42: The method of either one of Representative Paragraphs 24, the step of establishing the final cutting geometry further comprises identifying from the image an average thickness of the food block,
calculating a volume of the food block;
comparing the calculated volume of the food block with a maximum die volume for receipt of food blocks within a die of a pressing machine that is disposed to receive the cut food block, and comparing a maximum width for receipt of the food block within the pressing machine with the calculated average width;
identifying the rectangle for cutting the food block within the image with a possible front end cut, a possible right side cut, a possible left side cut, and a possible rear side cut positioned to establish a cut food block volume that is one of equal to the maximum die volume or as close as possible to the maximum volume based upon the average thickness of the food block within an area bounded by the rectangle for cutting the food block, wherein a distance between the possible left side cut and the possible right side cut is equal to or as close as possible to the maximum width.

Representative Paragraph 43: The method of Representative Paragraph 42, wherein the method includes one or more of the following possible adjustments:
a. identifying a difference in the geometry of the food item from the identified rectangle and adjusting the final cutting geometry to align one or more of the final cut sides to be similar to the geometry of the food item;
b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
c. identify if the food block includes any areas of high concentration of fat and adjusting the final cutting geometry to an area that avoids the identified high concentration of fat as possible; and
d. identify if the food block includes any voids within the area enclosed by the identified rectangle above a certain area or volume or above a certain proportion of a total area or volume of the food block, and adjust the final cutting geometry to an area that avoids the identified voids.

Representative Paragraph 44: The method of Representative Paragraph 43, identifying whether there is an established percent die fill of the pressing machine, wherein the percent die fill is a reduction or an increase of a volume of the food block with respect to maximum die volume;

wherein if the percent die fill is a percentage less than 100, reducing the size of the rectangle for cutting the food block such that a ratio of the reduced cut food block volume to the initially calculated food block volume will equal the percent die fill; and wherein if the percent die fill is a percentage greater than 100, increasing the size of the rectangle for cutting the food block such that the ratio of the increased cut food block volume to the initially calculated food block volume will equal the percent die fill.

Representative Paragraph 45: The method of any one of Representative Paragraphs 1-44, further comprising one or more of the disclosed method steps in the as-filed specification.

Representative Paragraph 46: The method of any one of Representative Paragraphs 1-45, further comprising cutting the food block along the final cutting geometry.

Representative Paragraph 47: The method of any one of Representative Paragraphs 1-46, further compressing pressing the cut food block along one or more of the X, Y, and Z axes.

Representative Paragraph 48: The method of any one of Representative Paragraphs 1-47 further comprising cutting the cut food block into multiple individual pieces.

Representative Paragraph 49: The method of Representative Paragraph 48, further comprising packaging one or more of the individual pieces into one or more individual packages.

1. A method to cut a food block, comprising
preparing an image of a food block, the food block provided within a system that is adapted to cut the food block into a size that is desired for sale, and in some embodiments for cutting into multiple smaller salable pieces;
identifying a rectangle for cutting a block of meat within a projection of the food block within the image, wherein the rectangle includes a possible front end cut, a possible right side cut, a possible left side cut, and a possible rear side cut;
considering adjustments to the size of the rectangle based upon one or more identifiable aspects of the food block from the image, and establishing a final cutting geometry with a final front end cut, final right side cut, final left side cut, and final rear side cut,
wherein the method includes one or more of the following possible adjustments:
a. identifying a difference in the geometry of the food item from the identified rectangle and adjusting the final cutting geometry to align one or more of the final cut sides to be similar to the geometry of the food item;
b. identify if the food block is oriented such that both left and right side surfaces are offset from the Y-axis, which is an axis about parallel to typical and left and right side surfaces, above a certain threshold value, and if above the certain threshold value, adjusting the angle of the final cutting lines to establish a cutting rectangle based upon this offset;
c. identify if the food block includes any areas of high concentration of fat and adjusting the final cutting geometry to an area that avoids the identified high concentration of fat as possible; and
d. identify if the food block includes any voids within the area enclosed by the identified rectangle above a certain area or volume or above a certain proportion of a total area or volume of the food block, and adjust the final cutting geometry to an area that avoids the identified voids.

2. The method of claim 1, wherein the method includes the adjustment of identifying a difference in the geometry of the food item from the identified rectangle and adjusting the final cutting geometry to align one or more of the final cut sides to be similar to the geometry of the food item.

3. The method of claim 2, further comprising establishing straight lines that best fit the actual geometry of food block, the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines.

4. The method of claim 3, further comprising comparing the second straight line with the possible left side cut and identifying a second angle therebetween, and
comparing the fourth straight line with the possible right side cut and identifying a fourth angle therebetween;
comparing the second angle and the fourth angle individually to a predetermined threshold angle;
if either the second angle or the fourth angle is larger than the predetermined threshold angle or if both of the right or left sides if larger than the predetermined threshold angle, establishing the respective final right side cut and/or the respective left side cut that is at an orientation that is equal to the predetermined threshold angle or at an angle with respect to the respective possible left side cut or the possible right side cut that is less than the predetermined threshold angle.

5. The method of claim 3, further comprising comparing one of (i) the second straight line with the possible left side cut and identifying a second angle therebetween, and
(ii) the fourth straight line with the possible right side cut and identifying a fourth angle therebetween;
comparing the chosen second angle or the fourth angle to a predetermined threshold angle;
if the chosen second angle or fourth angle is larger than the predetermined threshold angle, establishing the respective final right side cut or the respective left side cut at an orientation that is equal to the predetermined threshold angle or at an angle with respect to the respective possible left side cut or the possible right side cut that is less than the predefined threshold angle.

6. The method of claim 1, wherein the method includes the adjustment of identifying if the food block is oriented such that both left and right side surfaces are offset from the Y axis, which is an axis about parallel to typical and left and right side surfaces, above a certain threshold value, and if above the certain threshold value, adjusting the angle of the final cutting lines to establish a cutting rectangle based upon this offset.

7. The method of claim 6, further comprising establishing straight lines that best fit the actual geometry of the food block, wherein the established straight lines comprise a first straight line that best fits the front edge of the food block, a second straight line that best fits the left side edge of the food block, a third straight line that best fits the right rear edge of the food block, and a fourth straight line that best fits the right side edge of the food block, wherein each of the first through fourth straight lines establish a four sided polygon such that opposite ends of the first straight line connect with ends of the second and fourth straight lines, and ends of the third straight line connect with ends of the second and fourth straight lines,
further comprising comparing both of the second straight line and the fourth straight lines with a line (1007) that is parallel to a Y-axis of a coordinate system set up such that the Y-axis is a direction between the front and rear end surfaces of the rectangle and an X-axis is a direction parallel to the front and rear end surfaces of the rectangle and determining a differential angle between each of the respective second straight line and the fourth straight line and the line parallel to the Y-axis.

8. The method of claim 7, wherein if the comparison between both of the second and fourth straight lines with the line that is parallel to the Y-axis of the coordinate system results in both of the differential angles being greater than a threshold valve, determining that the food block is set up in an orientation that is offset from the Y axis;
wherein upon the determination that both of the differential angles are greater than the threshold value by a predetermined amount, physically removing the food block from the system to allow the food block to be at a later time to be repositioned to allow for again preparing an image of the food block.

9. The method of claim 7, wherein if the comparison between both of the second and fourth straight lines with the line that is parallel to the Y-axis of the coordinate system results in both of the differential angles being greater than a threshold valve, determining that the food block is set up in an orientation that is offset from the Y-axis, and establishing the final cutting geometry such that the final left side cut and the final right side cuts are each along parallel lines that are at an angle with respect to the Y-axis.

10. The method of claim 9, wherein the final left side cut and the final right side cut are along lines that are parallel to the one of the second or fourth straight lines that was at a larger differential angle.

11. The method of claim 9, wherein the final left side cut and the final right side cut are along lines that are parallel to a line that is at an angle that is equal to the average of the differential angle established with the second straight line and the Y-axis and the differential angle established with the fourth straight line and the Y-axis.

12. The method of claim 1, wherein the method includes the adjustment of identifying if the food block includes any areas of high concentration of fat and adjusting the final cutting geometry to an area that avoids this high concentration of fat as possible.

13. The method of claim 12, further comprising identifying in the image the portions of the food block that exhibit a high concentration of fat by identifying portions of the image that are of image quality that is correlated to the presence of a high concentration of fat when compared to remaining portions of the food block,
wherein from the identified portions of the food block that exhibit the high concentration of fat and when those identified portions are proximate to a right side edge or a left side edge of the food block, moving the rectangle for cutting the block in a direction parallel to a Y-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

14. The method of claim 12, further comprising identifying in the image the portions of the food block that exhibit a high concentration of fat by identifying portions of the a first certain predetermined image quality than remaining portions of the food block that exhibit second or other certain predetermined image qualities,
wherein from the identified portions of the food block that exhibit the high concentration of fat and when those identified portions are proximate to a front side edge or a rear side edge of the food block, moving the rectangle for cutting the block in a direction parallel to a X-axis of a coordinate plane such that the rectangle no longer covers a significant portion of the identified portion of the food block that exhibits the high concentration of fat, wherein the Y-axis is a direction between the front and rear end surfaces of the rectangle and the X-axis is a direction parallel to the front and rear end surfaces of the food block.

15. The method of claim 1, further comprising identifying if the food block includes any voids within an area enclosed by the identified rectangle above a certain area or volume or above a certain proportion of a total area or volume of the food block, and adjust the final cutting geometry to an area that avoids the identified voids.

16. The method of claim 15, further comprising identifying portions of the food block that exhibit the void in the image,
wherein from the identified portions of the food block that exhibit a void and when those identified portions are proximate to a right side edge or a left side edge of the food block, moving the rectangle for cutting the block in a direction parallel to a Y-axis of a coordinate plane such that the rectangle no longer covers a significant portion of the void, wherein the Y-axis is a direction between the front and rear end surfaces of the rectangle and the X-axis is a direction parallel to the front and rear end surfaces of the food block.

17. The method of claim 15, further comprising identifying the locations on the food block the locations that have a void by identifying portions of food block that do not have the image quality as they would if food block existed at that portion,
wherein from the identified portions of the food block that exhibit a void and when those identified portions are proximate to a front side edge or a rear side edge of the food block, moving the rectangle for cutting the block in a direction parallel to an X-axis of a coordinate plane such that the rectangle no longer covers a significant portion void, wherein the Y-axis is a direction between the front and rear end surfaces of the rectangle and the X-axis is a direction parallel to the front and rear end surfaces of the food block.

18. The method of claim 2,
wherein the method includes determining whether there is a minimum food thickness specified and if the minimum food thickness is specified, determining areas upon the food block where the measured thickness is less than the minimum food thickness, if the food block has any areas of food thickness that are below a minimum thickness level adjusting the final cutting geometry within the food block to a geometry and position that avoids as much of the food block with thickness less than the minimum food thickness as is possible.

19. The method of claim 18, wherein if the determined areas upon the food block where the measured thickness is less than the minimum food thickness are along or proximate to an outer edge of the food block, moving the final cutting geometry in a direction away from the outer edge of the food block that includes the measured thickness that is less than the minimum food thickness.

20. The method of claim 1, the step of establishing the final cutting geometry further comprises identifying a thickness of the food block,
calculating a volume of the food block;
comparing the calculated volume of the food block with a maximum die volume for receipt of food blocks within a die of a pressing machine that is disposed to receive the cut food block,
identifying a maximum width within the die;
identifying the rectangle for cutting the food block within the image with a possible front end cut, a possible right side cut, a possible left side cut, and a possible rear side cut positioned to establish a cut food block volume that is one of equal to the maximum die volume or as close as possible to the maximum die volume based upon the volume of the food block within an area bounded by the rectangle for cutting the food block, wherein a distance between the possible left side cut and the possible right side cut is equal to or as close as possible to the maximum width within the die.

21. The method of claim 20, identifying whether there is an established percent die fill of the pressing machine, wherein the percent die fill is a reduction or an increase of a volume of the food block with respect to maximum die volume;
wherein if the percent die fill is a percentage less than 100, reducing the size of the rectangle for cutting the food block such that a ratio of the reduced cut food block volume to the initially calculated food block volume will equal the percent die fill; and
wherein if the percent die fill is a percentage greater than 100, increasing the size of the rectangle for cutting the food block such that the ratio of the increased cut food block volume to the initially calculated food block volume will equal the percent die fill.
